(19) United States
(12) Patent Application Publication
(10) Pub. No.: US 2017/0253724 A1
(43) Pub. Date: Sep. 7, 2017

(54) Plasticizers Production and Use

(71) Applicant: ExxonMobil Chemical Patents Inc., Baytown, TX (US)

(72) Inventors: Didier A. Naert, Brussels (BE); Bernard F. Leroy, C'eroux-Mousty (BE)

(21) Appl. No.: 15/404,606

(22) Filed: Jan. 12, 2017

Related U.S. Application Data
(60) Provisional application No. 62/304,727, filed on Mar. 7, 2016.

(51) Int. Cl. C08K 5/101; C09D 127/06

(52) U.S. Cl. CPC C08K 5/101; C09D 127/06

(57) ABSTRACT

This disclosure relates to blends of aromatic ester plasticizers. The plasticizer blends include a first group of one or more methyl biphenyl carboxylic acid esters of C₇ to C₁₃ alcohol and a second group of methyl biphenyl carboxylic acid esters of C₄ to C₆ alcohol. The disclosure further relates to polymer compositions comprising the plasticizers and thermoplastic polymer, such as polyvinylchloride.

### CROSS REFERENCE TO RELATED APPLICATIONS

This invention claims priority to and the benefit of 62/304,727, filed Mar. 7, 2016, and relates to U.S. Ser. No. 62/304,718, filed Mar. 7, 2016, and is also related to U.S. Ser. No. 14/516,239, filed Oct. 16, 2014 and U.S. Ser. No. 14/319,906, filed Jun. 30, 2014.

### FIELD OF THE INVENTION

This disclosure relates to aromatic ester plasticizers and to plasticized compositions of the plasticizers in thermoplastic polymers, such as plasticized polyvinylchloride.

### BACKGROUND OF THE INVENTION

Plasticizers are incorporated into a resin (usually a plastic or elastomer) to increase the flexibility, workability, or distensibility of the resin. The largest use of plasticizers is in the production of “plasticized” or flexible polyvinyl chloride (PVC) products. Typical uses of plasticized PVC include films, sheets, tubing, coated fabrics, wire and cable insulation and jacketing, toys, flooring materials such as vinyl sheet flooring or vinyl floor tiles, adhesives, sealants, inks, and medical products such as blood bags and tubing, and the like.

Other polymer systems that use small amounts of plasticizers include polyvinyl butyral, acrylic polymers, nylon, polyolefins, polyurethanes, and certain fluoroplastics. Plasticizers can also be used with rubber (although often these materials fall under the definition of extenders for rubber rather than plasticizers). A listing of the major plasticizers and their compatibilities with different polymer systems is provided in “Plasticizers,” A. D. Godwin, in Applied Polymer Science 21st Century, edited by C. D. Craver and C. E. Carraher, Elsevier (2000); pp. 157-175.

Commonly assigned US 2015-0140350 identified plasticized vinyl chloride formulations using methyl biphenyl carboxylic acid esters. Suitable esters are methyl biphenyl carboxylate of C₄ to C₁₄ oxo alcohols. Commonly assigned US 2014-0315021 identified various blends of commercially available plasticizers with methyl biphenyl carboxylate esters.

A blend of methyl biphenyl carboxylate ester plasticizers having improved properties such as lower viscosity and improved gelation are desired. Such plasticizers would be useful in PVC plastisols.

### SUMMARY OF THE INVENTION

The present invention relates, in part, to the discovery that blends of methyl biphenyl carboxylic acid esters of C₇ to C₁₃ alcohol with methyl biphenyl carboxylic acid esters of C₄ to C₆ alcohol are especially good plasticizers. These mixtures exhibit low volatility, low viscosity and superior gelation and fusion properties when utilized as polymer plasticizer.

Accordingly, in one aspect, the present application provides blends comprising first and second groups of methyl biphenyl carboxylic acid esters. The first group of methyl biphenyl carboxylic acid esters corresponds to the following Formula 1:

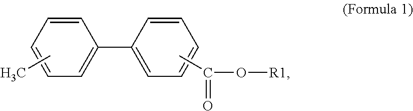

where R1 is a C₇ to C₁₃ alkyl residue of a C₇ to C₁₃ alcohol. The second group of methyl biphenyl carboxylic acid esters corresponds to the following Formula 2:

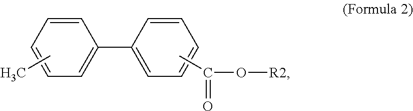

where R2 is a C₄ to C₆ alkyl residue of a C₄ to C₆ alcohol. Preferably, R1 is a C₉ to C₁₁ alkyl residue of a C₉ to C₁₁ alcohol.

In another aspect, the present application provides a polymer composition comprising a thermoplastic polymer and a plasticizer blend. The plasticizer blend comprises first and second groups of methyl biphenyl carboxylic acid esters. The first group of methyl biphenyl carboxylic acid esters corresponds to Formula 1 above where R1 is a C₇ to C₁₃ alkyl residue of a C₇ to C₁₃ alcohol. The second group of methyl biphenyl carboxylic acid esters corresponds to Formula 2 above where R2 is a C₄ to C₆ alkyl residue of C₄ to C₆ alcohol.

In another aspect, the present application provides a process for making a blend of methyl biphenyl carboxylic acid esters, comprising several steps. First, react benzene or alkylated benzene under conditions appropriate to form methyl biphenyl, or optionally alkylating biphenyl to form the methyl biphenyl. Second, oxidize the alkyl group(s) on the alkylated biphenyl to form at least one acid group. Third, contact a first portion of the acid group(s) with C₆ to C₁₃ alcohols under esterification conditions to form a first group of methyl biphenyl ester(s). Fourth, contact a second portion of the acid group(s) with C₃ to C₄ alcohols under esterification conditions to form a second group of methyl biphenyl ester(s). Finally, mix the first and second ester groups to form the ester blend.

It has further been observed that methyl biphenyl carboxylic acid ester isomers having the methyl and carboxylic acid ester substituents closer to the para positions have lower viscosity than other isomers of the same ester. Accordingly, preferred methyl biphenyl carboxylic acid ester(s) in the first and/or second groups are para-para (4′-4), meta-para (3′-4), para-meta (4′-3), and meta-meta (3′-3) isomers. The viscosity of the inventive methyl biphenyl carboxylic acid ester blends can be tailored by increasing or decreasing the concentration of isomers having substituents in the para-para, meta-para, para-meta, and/or meta-meta positions.

### BRIEF DESCRIPTION OF THE DRAWINGS

FIG. 1 shows viscosity of methyl biphenyl carboxylic acid esters.

FIG. 2 shows the viscosity as a function of shear rate for plastisol compositions.

FIG. 3 shows the storage modulus (G′) as a function of temperature for plastisol compositions obtained by dynamic mechanical analyzer.

### DETAILED DESCRIPTION OF THE INVENTION

All numerical values within the detailed description and the claims herein are modified by “about” or “approximately” the indicated value, and take into account experimental error and variations that would be expected by a person having ordinary skill in the art. Unless otherwise indicated, room temperature is about 23° C.

It has been determined that blends of i) a first group of methyl biphenyl carboxylic acid esters of C₇ to C₁₃ alcohol, preferably C₉ to C₁₁ alcohol, and ii) a second group methyl biphenyl carboxylic acid esters of C₄ to C₆ alcohol, are useful as low viscosity plasticizers.

Blends comprising i) a first group of one or more compounds of the following Formula 1:

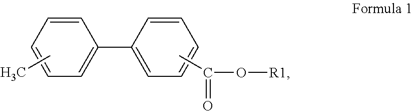

wherein R1 is a C₇ to C₁₃ alkyl, preferably an alkyl residue of a C₇ to C₁₃ alcohol, and ii) a second group of one or more compounds of the following Formula 2:

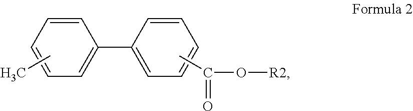

wherein R2 is a C₄ to C₆ alkyl, preferably an alkyl residue of a C₄ to C₆ alcohol, are useful as low viscosity plasticizers. Preferably, R1 is a C₉ to C₁₁ alkyl, preferably an alkyl residue of a C₉ to C₁₁ alcohol.

Suitable methyl biphenyl carboxylic acid esters useful in the invention and their method of production are described in US 2015-0140350, which is fully incorporated herein by reference.

It has been discovered that methyl biphenyl carboxylic acid esters based on C₇ to C₁₃ alcohols, preferably C₉ to C₁₁ alcohol, are particularly useful as plasticizers offering good gelation and low volatility. Additionally, low viscosity plasticisers are particularly useful in PVC plastisols where they reduce the plastisol initial viscosity as well as the plastisol viscosity under shear stress. It has been found that methyl biphenyl carboxylic acid esters of butyl, pentyl, or hexyl (C₄ to C₆) alcohols exhibit the lowest neat viscosity. It has been further discovered that blends of a first group of methyl biphenyl carboxylic acid esters of C₇ to C₁₃ alcohol with a second group of methyl biphenyl carboxylic acid esters of C₄ to C₆ alcohol retain the low volatility while further improving the gelation of the higher alcohol esters while also exhibiting lower combined viscosity.

### Methyl Biphenyl Carboxylic Acid Ester Isomers

The first and second group of esters in the inventive blends are made of one or more isomers of the methyl biphenyl carboxylic acid esters written generically n′-methyl biphenyl-n-carboxylic acid esters. The position numbering (n′ and n) for substituents on biphenyl is as indicated in following formula:

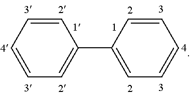 [SMILES: c1ccc(-c2ccccc2)cc1]

Suitable isomers of the methyl biphenyl carboxylic acid esters useful in the inventive ester blends include 4′-methylbiphenyl-4-carboxylic acid ester (“4′-4” or “para-para”), 4′-methylbiphenyl-3-carboxylic acid ester (“4′-3” or “para-meta”), 4′-methylbiphenyl-2-carboxylic acid ester (“4′-2” or “para-ortho”) respectively represented by the formulas:

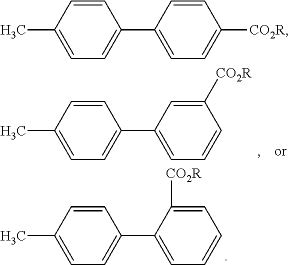

wherein R is an alkyl, preferably an alkyl residue of an alcohol.

Suitable isomers of the methyl biphenyl carboxylic acid esters useful in the first and second groups of the inventive ester blends also include 3′-methylbiphenyl-4-carboxylic acid ester (“3′-4” or “meta-para”), 3′-methylbiphenyl-3-carboxylic acid ester (“3′-3” or “meta-meta”), 3′-methylbiphenyl-2-carboxylic acid ester (“3′-2” or “meta-ortho”) respectively represented by the formulas:

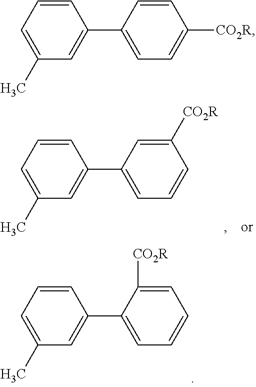

wherein R is an alkyl, preferably an alkyl residue of an alcohol.

Suitable isomers of the methyl biphenyl carboxylic acid useful in the first and second groups of the inventive ester blends also include 2′-methylbiphenyl-4-carboxylic acid ester (“2′-4” or “ortho-para”), 2′-methylbiphenyl-3-carboxylic acid ester (“2′-3” or “ortho-meta”), 2′-methylbiphenyl-2-carboxylic acid ester (“2′-2” or “ortho-ortho”) respectively represented by the formulas:

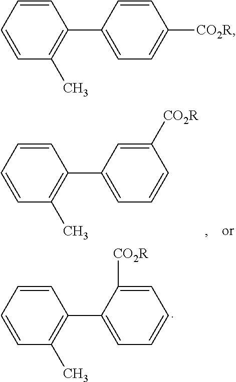

wherein R is an alkyl, preferably an alkyl residue of an alcohol.

It has been observed that methyl biphenyl carboxylic acid ester isomers having the methyl and carboxylic acid ester substituents closer to the para positions have lower viscosity than other isomers of the same ester. The para-para (4′-4) isomer of methyl biphenyl carboxylic acid ester has a lower viscosity than the para-meta (4′-3) or meta-para (3′-4) isomers of the same ester. Additionally, the para-meta (4′-3) and meta-para (3′-4) isomers of methyl biphenyl carboxylic acid ester have lower viscosity than the meta-meta (3′-3) isomers of the same ester. The meta-meta (3′-3) isomer of methyl biphenyl carboxylic acid ester has lower viscosity than the meta-ortho (3′-2), ortho-meta (2′-3), and ortho-ortho (2′-2) isomers of the same ester.

Preferably, the methyl biphenyl carboxylic acid ester(s) isomers in the inventive blends are para-para (4′-4), para-meta (4′-3), meta-para (3′-4), and meta-meta (3′-3) isomers. More preferably, the methyl biphenyl carboxylic acid ester(s) isomers in the inventive blends are para-para (4′-4), para-meta (4′-3), and meta-para (3′-4) isomers. Even more preferably, the methyl biphenyl carboxylic acid ester(s) isomers in the inventive blends are the para-para (4′-4) isomers.

It has been observed that carboxylic acid ester substituent position in the methyl biphenyl carboxylic acid ester has a stronger influence on viscosity of the ester than does the methyl substituent. The meta-para (3′-4) isomer of methyl biphenyl carboxylic acid ester has lower viscosity than the para-meta (4′-3) isomer of the same ester. Likewise, the ortho-meta (2′-3) isomer of methyl biphenyl carboxylic acid ester has lower viscosity than the meta-ortho (3′-2) isomer of the same ester.

Preferable isomers have the carboxylic acid ester substituent located in the para or meta position. More preferable, the isomers have the carboxylic acid ester substituent located in the para position.

Preferably, the methyl biphenyl carboxylic acid ester(s) isomers in the inventive blends are para-para (4′-4), meta-para (3′-4), para-meta (4′-3), and meta-meta (3′-3) isomers. More preferably, the methyl biphenyl carboxylic acid ester(s) isomers in the inventive blends are para-para (4′-4), meta-para (3′-4), and para-meta (4′-3) isomers. Even more preferably, the methyl biphenyl carboxylic acid ester(s) isomers in the inventive blends are para-para (4′-4) and meta-para (3′-4) isomers.

Advantageously, the viscosity of the inventive methyl biphenyl carboxylic acid ester blends can be tailored by increasing or decreasing the concentration of isomers having substituents in the para-para, meta-para, para-meta, and/or meta-meta positions according to the above observations. One non-limiting example application is increasing the concentration of para-para (4′-4) isomers to lower the viscosity of a blend of meta-meta (3′-3) and para-meta (4′-3) isomers of methyl biphenyl carboxylic esters. Various other applications will be understood by one having ordinary skill in the art.

It has been further observed that para-para (4′-4) isomers of methyl biphenyl carboxylic acid esters, particularly esters of more linear alcohols, tend to form undesirable solids. Without being limited by any theory, it is believed that the structure afforded by the (4′-4) isomer and the more linear alcohols contributes to the ester forming a solid. However, it has been found that mixing para-para (4′-4) isomers with increasing amounts of the other isomers avoid the undesirable solid condition. Preferably, the inventive ester mixtures comprise ≦50 wt % para-para (4′-4) isomers.

In an embodiment of the invention, the blend comprises from 20 to 50 wt % of para-para (4′-4) and/or meta-para (3′-4) isomers; from 50 to 80 wt % para-meta (4′-3) isomers; and ≦15 wt %, preferably ≦10 wt %, more preferably ≦5 wt % meta-meta (3′-3) isomers.

In another embodiment of the invention, the blend comprises from 20 to 50 wt % of para-para (4′-4) isomers; from 50 to 80 wt % para-meta (4′-3) isomers and/or meta-para (3′-4); and ≦15 wt %, preferably ≦10 wt %, more preferably ≦5 wt % meta-meta (3′-3) isomers.

### First Group Methyl Biphenyl Carboxylic Acid Esters

In any embodiment of the invention, the blends comprise a first group of methyl biphenyl carboxylic acid esters (“first group” or “first esters”). The first group comprises one or more compounds of Formula 1 as indicated previously and copied here for convenient reference:

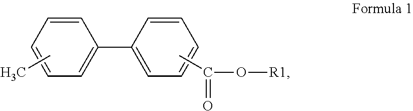

wherein R1 is a C₇ to C₁₃ alkyl, preferably an alkyl residue of a C₇ to C₁₃ alcohol. Preferably, R1 is a C₉ to C₁₁ alkyl, preferably an alkyl residue of a C₉ to C₁₁ alcohol. When an ester is formed from an alcohol, the alkyl residue retains the structure and structure related properties (e.g., ACN, branching index, etc.) of the alcohol other than removal of the OH⁻ group.

Preferably, R1 alkyls of the first group of esters are alkyl residues of one or more alcohols having an average carbon number (“ACN”) from 7.0 to 13.0, preferably 9.0 to 11.0, most preferably from 9.0 to 9.4.

For purposes of this specification, the term “average carbon number” means the carbon number of a single molecule or the average of individual molecule carbon numbers in a group of molecules. The average carbon number (ACN) of the alcohols is determined by ¹H NMR. The nature and average carbon number of the alkyls present in the esters described here (e.g. first or second group of esters) can be determined by saponifying the ester in basic solution and then analyzing the resulting alcohol mixture by ¹H NMR spectroscopy.

In preferable embodiments of the invention, the first group of ester R1 alkyls are residuals of primarily C₉ alcohols having a degree of branching ranging from 0.0 to 3.0, preferably from 0.0 to 2.2, e.g., from 0.0 to 2.0, and an average carbon number (“ACN”) from 9.0 to 9.4. In one embodiment, different alcohols that have a carbon number ranging from 8 to 11 (C₈ to C₁₁), preferably from 9 to 10 (C₉ to C₁₀) are employed to make the esters in the mixture. In a preferred embodiment, different nonyl alcohols are employed to make the ester. In another embodiment only one nonyl alcohol is employed to make the esters in the mixture. Suitable alcohols are described in U.S. Pat. No. 8,329,796; U.S. Pat. No. 7,786,201; and U.S. Pat. No. 6,437,170, which are fully incorporated herein by reference.

In any embodiment of the invention described herein, the first ester comprises a C₇ to C₁₃ alkyl residue of a C₇ to C₁₃ alcohol having a degree of branching from 0.0 to 5.0, such as 0.2 to 5.0. In any embodiment of the invention described herein, the first ester comprises alkyl residual(s) of alcohol(s) having a degree of branching 0.05 to 0.4 at the alcoholic beta carbon. In any embodiment of the invention described herein, the first ester comprises alkyl residual(s) of alcohol(s) having a degree of branching of at least 1.3 to 5.0 of methyl branches. In any embodiment of the invention described herein, the first ester comprises alkyl residual(s) of alcohol(s) having a degree of branching from 0.35 to 1.5 of pendant methyl branches.

It has been found that viscosity of the methyl biphenyl carboxylic acid esters can be reduced by increasing linearity (decreasing degree of branching) of the alkyl residuals of alcohols. Suitable alcohols have a degree of branching from 0.0 to 3.0, including 0.0 to 2.2, 0.0 to 2.0, 1.0 to 2.2, 1.0 to 2.0, 1.1 to 2.1, 1.1 to 2.0, 1.2 to 2.0, 1.2 to 1.9, 1.2 to 1.5, 1.3 to 1.8, and from 1.3 to 1.7.

In a preferable embodiment of the invention, the first esters comprise one or more alkyl residuals of alcohol whose degree of branching is from 0.0 to 3.0, preferably from 0.0 to 2.2, e.g., from 0.0 to 2.0, and have an ACN from 9.0 to 9.4. Commercially available suitable alcohols include, but are not limited to, EXXAL™ 9 (ExxonMobil), EXXAL™ 9S (ExxonMobil), EXXAL™ 9YPF (ExxonMobil), Linevol 9 (Shell), Isononanol (EVONIK), and Isononanol (INA) (BASF).

¹H NMR methods or ¹³C NMR methods can be used to determine the degree of branching of the alcohol. According to the present invention, it is preferable to determine the degree of branching with the aid of ¹H NMR spectroscopy on a solution of the esters in deuterochloroform (CDCl₃). The spectra are recorded by way of example by dissolving 20 mg of substance in 0.6 ml of CDCl₃, comprising 1% by weight of tetramethylsilane (TMS), and charging the solution to an NMR tube whose diameter is 5 mm Both the substance to be studied and the CDCl₃ used can first be dried over molecular sieve in order to exclude any errors in the values measured due to possible presence of water. The method of determination of the degree of branching is advantageous in comparison with other methods for the characterization of alcohol moieties, described by way of example in WO 03/029339, since water contamination in essence has no effect on the results measured and their evaluation. In principle, any commercially available NMR equipment can be used for the NMR-spectroscopic studies. The present NMR-spectroscopic studies used INOVA 500 equipment from Varian. The spectra were recorded at a temperature of 300 K using a delay of d1=10 seconds, 64 scans, a pulse length of 9.7 μs and a sweep width of 13 000 Hz, using a 5 mm BBO (broad band observer) probe head. The resonance signals are recorded in comparison with the chemical shifts of tetramethylsilane (TMS=0 ppm) as internal standard. Comparable results are obtained with other commercially available NMR equipment using the same operating parameters.

The degree of branching B can therefore be calculated from the measured intensity ratio in accordance with the following formula:

B=2/3*I(CH₃)/I(OCH₂)−1

B is degree of branching, I(CH₃) is the area integral essentially attributed to the methyl hydrogen atoms, and I(OCH₂) is the area integral for the methylene hydrogen atoms adjacent to the oxygen atom.

The average carbon number (ACN) can therefore be calculated from the measured intensity ratio in accordance with the following formula:

ACN=I(CH₂,CH(OH)+I(CH₃)/I(OCH₂)

where ACN is the average carbon number, I(CH₃) is the area integral essentially attributed to the methyl hydrogen atoms, and I(OCH₂) is the area integral for the methylene hydrogen atoms adjacent to the oxygen atom.

The first ester R1 alkyl can also be an alkyl residual of OXO-alcohols, the formation of which is described in more detail below.

“OXO-alcohols” are isomeric linear, branched, or mixtures of linear and branched, organic alcohols. “OXO-esters” are compounds having at least one functional ester moiety within its structure derived from esterification of a carboxylic acid portion or moiety of a compound with an OXO-alcohol.

OXO-alcohols can be prepared by hydroformylating olefins, followed by hydrogenation to form the alcohols. “Hydroformylating” or “hydroformylation” is the process of reacting a compound having at least one carbon-carbon double bond (an olefin) in an atmosphere of carbon monoxide and hydrogen over a cobalt or rhodium catalyst, which results in addition of at least one aldehyde moiety to the underlying compound. U.S. Pat. No. 6,482,972, which is fully incorporated herein by reference in its entirety, describes the hydroformylation (OXO) process. The resulting OXO-alcohols consist of multiple isomers of a given chain length due to the various isomeric olefins obtained in the oligomerization process, described below, in tandem with the multiple isomeric possibilities of the hydroformylation step.

Typically, the isomeric olefins are formed by light olefin oligomerization over heterogeneous acid catalysts, such as by propylene and/or butene oligomerization over solid phosphoric acid or zeolite catalysts. The light olefins are readily available from refinery processing operations. The reaction results in mixtures of longer-chain, branched olefins, which are subsequently formed into longer chain, branched alcohols, as described below and in U.S. Pat. No. 6,274,756, fully incorporated herein by reference in its entirety. Olefins for hydroformylation can also be prepared by dimerization of propylene or butenes through commercial processes such as the IFP Dimersol™ process or the Huls (Evonik) Octol™ process.

Branched aldehydes are then produced by hydroformylation of the isomeric olefins. The resulting branched aldehydes can then be recovered from the crude hydroformylation product stream by fractionation to remove unreacted olefins. These branched aldehydes can then be hydrogenated to form alcohols (OXO-alcohols). Single carbon number alcohols can be used in the esterification of the acids described above, or differing carbon numbers can be used to optimize product cost and performance requirements. The “OXO” technology provides cost advantaged alcohols.

“Hydrogenating” or “hydrogenation” is addition of hydrogen (H₂) to a double-bonded functional site of a molecule, such as in the present case the addition of hydrogen to the aldehyde moieties of a di-aldehyde, to form the corresponding di-alcohol, and saturation of the double bonds in an aromatic ring. Conditions for hydrogenation of an aldehyde are well-known in the art and include, but are not limited to temperatures of 0-300° C., pressures of 1-500 atmospheres, and the presence of homogeneous or heterogeneous hydrogenation catalysts such as, but not limited to Pt/C, Pt/Al₂O₃ or Pd/Al₂O₃ and Ni. Useful hydrogenation catalysts include platinum, palladium, ruthenium, nickel, zinc, tin, cobalt, or a combination of these metals, with palladium being particularly advantageous.

Alternatively, the OXO-alcohols can be prepared by aldol condensation of shorter-chain aldehydes to form longer chain aldehydes, as described in U.S. Pat. No. 6,274,756, followed by hydrogenation to form the OXO-alcohols.

### Second Alcohol Moieties

As discussed above, it has been discovered that methyl biphenyl carboxylic acid esters of butyl, pentyl, or hexyl (C₄ to C₆) alcohols exhibit the lowest neat viscosity. In any embodiment of the invention, the blends comprise a second group of methyl biphenyl carboxylic acid esters (“second group” or “second esters”). The second group comprises one or more compounds of Formula 2 as indicated previously and copied here for convenient reference:

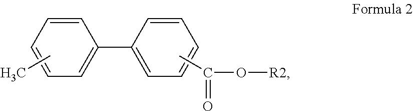

wherein R2 is a C₄ to C₆ alkyl, preferably an alkyl residue of a C₄ to C₆ alcohol.

It has been further discovered that blends of i) a first group of methyl biphenyl carboxylic acid esters of C₇ to C₁₃ alcohol, preferably C₉ to C₁₁ alcohol, and ii) a second group methyl biphenyl carboxylic acid esters of C₄ to C₆ alcohol, retain the gelation of the higher carbon number alcohol esters while also exhibiting lower viscosity of esters made of C₄ to C₆ alcohols.

The second group of methyl biphenyl carboxylic acid esters (“second esters”) R2 is a C₄ to C₆ alkyl residue of a C₄ to C₆ alcohol. The second esters can comprise the same alkyl or they can comprise a mixture of alkyls. The second ester R2 alkyl can be an alkyl residue of an alcohol having an average carbon number (“ACN”) from 4.0 to 6.0. The second ester R2 alkyl can be linear or branched.

In preferable embodiments, the second ester R2 alkyls are alkyl residue(s) of one or more C₄ to C₆ OXO-alcohols.

In an embodiment of the methyl biphenyl carboxylic acid ester blend, the first ester is present at 0.1 to 99.9 wt % (preferably 1 to 99 wt %, preferably 5 to 95 wt %, preferably 10 to 90 wt %), the second ester is present at 99.9 to 0.1 wt % (preferably 99 to 1 wt %, preferably 95 to 5 wt %, preferably 90 to 10 wt %), based upon the weight of the blend.

In an embodiment, the blend comprises ≧1 wt % second ester, for example, ≧5 wt %, ≧10 wt %, ≧15 wt %, ≧20 wt %, ≧30 wt %, ≧40 wt %, ≧50 wt %, ≧60 wt % second ester, based upon the weight of the blend.

In an embodiment, the blend comprises from 1 to 60 wt % second ester, for example, from 5 to 40 wt %, preferably from 10 to 30 wt %, based upon the weight of the blend.

### Producing Methyl Biphenyl Carboxylic Acid Esters

One route to the methyl biphenyl carboxylic acid based esters of the present disclosure is by combination of two benzene molecules, by controlled hydrogenation, as follows:

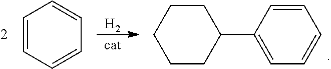

According to this method, the cyclohexyl benzene so formed can be dehydrogenated to form biphenyl as follows:

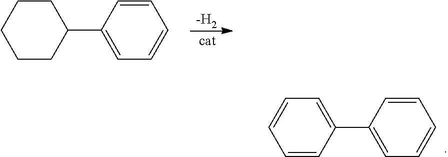

The aromatic ring(s) are subsequently alkylated with an alcohol, such as methanol, which acts to add one or more methyl groups to the ring(s), followed by oxygenation of one of the pendant methyl group(s) to form a carboxylic acid group, and subsequently esterified with a specified alcohol to form methyl biphenyl carboxylic acid first or second esters of the present disclosure.

Another route to plasticizers of the present disclosure is by oxidative coupling of two benzene molecules to form biphenyl, as follows: For benzene coupling: Ukhopadhyay, Sudip; Rothenberg, Gadi; Gitis, Diana; Sasson, Yoel. Casali Institute of Applied Chemistry, Hebrew University of Jerusalem, Israel. Journal of Organic Chemistry (2000), 65(10), pp. 3107-3110. Publisher: American Chemical Society, incorporated herein by reference.

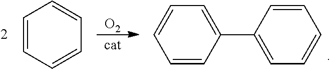

Similarly to the first process, the biphenyl molecule is then alkylated, for example, with an alcohol, such as methanol, to add one or more methyl groups to the ring(s), followed by oxygenation of the pendant methyl group to form carboxylic acid group, and subsequently esterified with a specified alcohol to form the first or second esters of the present disclosure.

Of course, a similar process can be followed utilizing an alkyl aromatic, such as toluene as the starting material in place of benzene. Either monoesters or diesters can be formed, or both, depending on reaction conditions. Likewise, by appropriate control of the oxidation step so as to oxidize only one of the pendant methyl groups, monoester compounds of the following general formula can be formed:

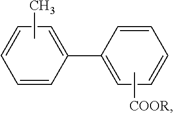

where R is an alkyl, preferably and alkyl residue of an alcohol.

“Esterifying” or “esterification” is reaction of a carboxylic acid moiety, such as an anhydride, with an organic alcohol moiety to form an ester linkage. Esterification conditions are well-known in the art and include, but are not limited to, temperatures of 0-300° C., and the presence or absence of homogeneous or heterogeneous esterification catalysts such as Lewis or Brønsted acid catalysts.

In a preferred embodiment, this invention relates to a process for making a blend of methyl biphenyl carboxylic acid esters, comprising the steps of: reacting benzene or alkylated benzene under conditions appropriate to form methyl biphenyl; optionally alkylating biphenyl to form said methyl biphenyl; oxidizing the alkyl group(s) on said alkylated biphenyl to form at least one carboxylic acid group; contacting a first portion of said carboxylic acid group(s) with C₇ to C₁₃, preferably C₉ to C₁₁, alcohols under esterification conditions to form a first group of methyl biphenyl carboxylic acid ester(s); contacting a second portion of said carboxylic acid group(s) with C₄ to C₆ alcohols under esterification conditions to form a second group of methyl biphenyl ester(s); and mixing the first and second groups of esters to form said blend.

In a preferred embodiment of the invention, the first portion of said acid group(s) is contacted with alcohols having a degree of branching from 0.0 to 3.0, preferably from 0.0 to 2.2, e.g., from 0.0 to 2.0, and an average carbon number (ACN) from 9.0 to 9.4.

In a preferred embodiment of the invention, the alkylating step is conducted in the presence of an acid catalyst.

In a preferred embodiment of the invention, the reacting step is conducted with benzene, further comprising the steps of: hydroalkylating benzene by reacting benzene in the presence of H₂ to hydrogenate one mole of said benzene to form cyclohexene, alkylating benzene with said cyclohexene to form cyclohexylbenzene; dehydrogenating said cyclohexylbenzene to form biphenyl; and alkylating one or both aromatic moieties of said biphenyl to form said alkylated biphenyl, where preferably the hydroalkylating step is conducted in the presence of a hydrogenation catalyst, the alkylating step is conducted with an alkylation catalyst, and the dehydrogenating step is conducted with a dehydrogenation catalyst.

In a preferred embodiment of the invention, the hydrogenation catalyst is selected from the group consisting of platinum, palladium, ruthenium, nickel, zinc, tin, cobalt, or a combination of these metals, with palladium being particularly advantageous; the alkylation catalyst is selected from the group consisting of Zeolite, mixed metal oxides and the dehydrogenation catalyst is selected from the group consisting of platinum, pladium, Ru, Rh, nickel, zinc, tin, cobalt and combinations thereof.

In a preferred embodiment of the invention, the reacting step is conducted with benzene in the presence of oxygen and an oxidative coupling catalyst, forming biphenyl, further comprising the step of: alkylating one or both aromatic moieties of said biphenyl to form said alkylated biphenyl, preferably the alkylating step is conducted with an alkylation catalyst.

In a preferred embodiment of the invention, the reacting step is conducted with toluene, further comprising the steps of: reacting toluene in the presence of H₂ and a hydrogenation catalyst to form methyl cyclohexene; reacting said methyl cyclohexene with toluene in the presence of an alkylation catalyst to form dimethyl cyclohexylbenzene; and dehydrogenating said dimethyl cyclohexylbenzene in the presence of a dehydrogenation catalyst to form the alkylated biphenyl, which is preferably dimethyl-biphenyl.

In a preferred embodiment of the invention, after contacting the carboxylic acid group(s) with an alcohol under esterification conditions, the esterification product is contacted with a basic solution such as saturated sodium bicarbonate or a caustic soda wash.

In a preferred embodiment of the invention, after contacting the carboxylic acid group(s) with an OXO-alcohol under esterification conditions, the esterification product is contacted with a basic solution such as saturated sodium bicarbonate or a caustic soda wash.

In a preferred embodiment of the invention, the crude esters are further stripped to remove excess alcohol and the stripped esters are treated with activated carbon to improve the liquid volume resistivity of the plasticizer.

### Polymer Compositions

In general, for every polymer resin to be plasticized, a plasticizer is required with a good balance of polarity or solubility (providing desired compatibility with the polymer resin) and also with low volatility and low viscosity. Higher viscosity plasticizers have negatively affected processability that requires heating during mixing and formulation of the polymer and the plasticizer. Higher plasticizer viscosity has similar effects on the processability of PVC plastisols containing the plasticizer.

Volatility is also an important factor which affects the ageing or durability of the plasticized polymer. Highly volatile plasticizers will diffuse and evaporate from the plastic resin matrix, thus losing mechanical strength in applications requiring long term stability/flexibility. Plasticizer loss from a resin matrix due to plasticizer volatility can be evaluated following ASTM D2288 by heating 10 g of plasticizer for 24 h at 155° C. and measuring the resulting weight loss.

It has been found that the inventive methyl biphenyl carboxylic acid ester blends described herein are in the form of relatively high-boiling liquids (having low volatility), which are readily incorporated into polymer formulations as plasticizers. Additionally, it has been found that the methyl biphenyl carboxylic acid esters based on such alcohols can have viscosity, ≦180 mPa·s, preferably ≦150 mPa·s, more preferably ≦120 mPa·s, even more preferably ≦100 mPa·s, still even more preferably ≦95 mPa·s, measured by Antoon Paar Viscosimeter at 20° C. following ASTM D445.

Any of the ester blends described herein can be used as plasticizers for polymers, such as vinyl chloride resins, polyesters, polyurethanes, silylated polymers, polysulfides, acrylics, ethylene-vinyl acetate copolymer, rubbers, poly(meth)acrylics and combinations thereof, preferably polyvinylchloride.

In an embodiment of the invention, a polymer composition exhibiting low volatility, good gelation, and lower viscosity comprises a thermoplastic polymer and a plasticizer blend, where the plasticizer blend comprises a first group of one or more methyl biphenyl carboxylic acid esters of C₇ to C₁₃, preferably C₉ to C₁₁, alcohol, and a second group of methyl biphenyl carboxylic acid esters of C₄ to C₆ alcohol.

In an embodiment of the invention, a polymer composition comprises a thermoplastic polymer and a plasticizer blend, where the plasticizer blend comprises i) a first group of one or more compounds of the above specified Formula 1, wherein R1 is a C₇ to C₁₃ alkyl, preferably an alkyl residue of a C₇ to C₁₃ alcohol, and ii) a second group of one or more compounds of the above specified Formula 2, wherein R2 is a C₄ to C₆ alkyl, preferably an alkyl residue of a C₄ to C₆ alcohol, are useful as low viscosity plasticizers. Preferably, R1 is a C₉ to C₁₁ alkyl, preferably an alkyl residue of a C₉ to C₁₁ alcohol.

Preferably, the thermoplastic polymer is selected from the group consisting of vinyl chloride resins, polyesters, polyurethanes, silyl terminated polyether, ethylene-vinyl acetate copolymer, rubbers, poly(meth)acrylics and combinations thereof, alternately the polymer is selected from the group consisting of polyvinyl chloride (PVC), polyvinylidene chloride, a copolymer of polyvinyl chloride and polyvinylidene chloride, and polyalkyl methacrylate (PAMA), preferably the polymer is a copolymer of vinyl chloride with at least one monomer selected from the group consisting of vinylidene chloride, vinyl acetate, vinyl propionate, vinyl butyrate, vinyl benzoate, methyl acrylate, ethyl acrylate, and butyl acrylate.

In any embodiment of the invention, the polymer composition comprises a thermoplastic polymer and a plasticizer blend, the amount of plasticizer blend is from 5 to 90 wt %, based upon the weight of the polymer and plasticizer blend, preferably from 10 to 100 wt %, even more preferably in the range from 15 to 90 wt %, preferably in the range from 20 to 80 wt %.

The polymer composition comprising a thermoplastic polymer and at least one plasticizer blend described herein may optionally contain further additional plasticizers other than those produced herein, such as: dialkyl (ortho)phthalate, preferably having 4 to 13 carbon atoms in the alkyl chain; trialkyl trimellitates, preferably having 4 to 10 carbon atoms in the side chain; dialkyl adipates, having 4 to 13 carbon atoms; dialkyl sebacates preferably having 4 to 13 carbon atoms; dialkyl azelates preferably having 4 to 13 carbon atoms; preferably dialkyl terephthalates each preferably having 4 to 8 carbon atoms and more particularly 4 to 7 carbon atoms in the side chain; alkyl 1,2-cyclohexanedicarboxylates, alkyl 1,3-cyclohexanedicarboxylates and alkyl 1,4-cyclohexanedicarboxylates, and preferably here alkyl 1,2-cyclohexanedicarboxylates each preferably having 4 to 13 carbon atoms in the side chain; dibenzoic esters of glycols; alkylsulfonic esters of phenol with preferably one alkyl radical containing 8 to 22 carbon atoms; polymeric plasticizers (based on polyester in particular), glyceryl esters, acetylated glycerol esters, epoxy estolide fatty acid alkyl esters, citric triesters having a free OH group or are acetylated with for example alkyl radicals of 4 to 9 carbon atoms, alkylpyrrolidone derivatives having alkyl radicals of 4 to 18 carbon atoms and also alkyl benzoates, preferably having 7 to 13 carbon atoms in the alkyl chain. In all instances, the alkyl radicals can be linear or branched and the same or different.

The polymer composition comprising a thermoplastic polymer and at least one plasticizer blend described herein prepared according to the present invention may further contain additives to optimize the chemical, mechanical or processing properties, said additives being more particularly selected from the group consisting of fillers, such as calcium carbonate, titanium dioxide or silica, pigments, thermal stabilizers, antioxidants, UV stabilizers, lubricating or slip agents, flame retardants, antistatic agents, biocides, impact modifiers, blowing agents, (polymeric) processing aids, viscosity depressants or regulators such as thickener and thinners, antifogging agents, optical brighteners, etc.

Thermal stabilizers useful herein include all customary polymer stabilizers, especially PVC stabilizers in solid or liquid form, examples are those based on Ca/Zn, Ba/Zn, Pb, Sn or on organic compounds (OBS), and also acid-binding phyllosilicates such as hydrotalcite. The polymer compositions to be used according to the present invention may have a thermal stabilizer content of 0.5 to 10, preferably 0.8 to 5 and more preferably 1.0 to 4 wt %, based upon the weight of the polymer composition.

It is likewise possible to use costabilizers with plasticizing effect in the polymer composition comprising a thermoplastic polymer and at least one plasticizer blend as described herein, in particular epoxidized vegetable oils, such as epoxidized linseed oil or epoxidized soya oil.

Antioxidants are also useful in the polymer composition comprising a thermoplastic polymer and at least one plasticizer blend described herein and can include sterically hindered amines—known as HALS stabilizers, sterically hindered phenols, such as Topanol™ CA, phosphites, UV absorbers, e.g., hydroxybenzophenones, hydroxyphenylbenzotriazoles and/or aromatic amines. Suitable antioxidants for use in the compositions of the present invention are also described for example in “Handbook of Vinyl Formulating” (editor: R. F. Grossman; J. Wiley & Sons; New Jersey (US) 2008). The level of antioxidants in the mixtures of the present invention is typically not more than 10 phr, preferably not more than 8 phr, more preferably not more than 6 phr and even more preferably between 0.01 and 5 phr (phr=parts per hundred parts of polymer composition).

Organic and inorganic pigments can be also used in the polymer composition comprising a thermoplastic polymer and at least one plasticizer blend as described herein. The level of pigments in the compositions to be used according to the present invention is typically not more than 10 phr, preferably in the range from 0.01 to 5 phr and more preferably in the range from 0.1 to 3 phr. Examples of useful inorganic pigments are TiO₂, CdS, CoO/Al₂O₃, Cr₂O₃. Examples of useful organic pigments are for example azo dyes, phthalocyanine pigments, dioxazine pigments and also aniline pigments.

The polymer composition comprising a thermoplastic polymer and at least one plasticizer blend described herein may contain one or more filler, including mineral and/or synthetic and/or natural, organic and/or inorganic materials, for example, calcium oxide, magnesium oxide, calcium carbonate, barium sulphate, silicon dioxide, phyllosilicate, carbon black, bitumen, wood (e.g., pulverized, as pellets, micropellets, fibers, etc.), paper, natural and/or synthetic fibers, glass, etc.

The compositions described herein can be produced in various ways. In general, however, the composition is produced by intensively mixing all components in a suitable mixing container at elevated temperatures. The plastic pellet or powder (typically suspension PVC, microsuspension PVC or emulsion PVC) is typically mixed mechanically, i.e., for example in fluid mixers, turbomixers, trough mixers or belt screw mixers with the plasticizer blend and the other components at temperatures in the range from 60° C. to 140° C., preferably in the range from 80° C. to 100° C. The components may be added simultaneously or, preferably, in succession (see also E. J. Wickson “Handbook of PVC Formulating”, John Wiley and Sons, 1993, pp. 747-ff). The polymer composition of PVC, plasticizer and other additive as described above (e.g., the PVC compound or the PVC paste) is subsequently sent to the appropriate thermoplastic moulding processes for producing the finished or semi-finished article, optionally a pelletizing step is interposed.

The polymer compositions (e.g., the PVC compound or the PVC paste) are particularly useful for production of garden hoses, pipes, and medical tubing, floor coverings, flooring tiles, underbody car coating and sealants, latex and caulk, films, sheeting, roofing, or roofing webs, pool liners, building protection foils, upholstery, and cable filling compound, sheathing and wire insulation, particularly wire and cable coating, coated textiles and wall coverings.

The plasticizers of the invention are useful across the range of plasticized polyvinyl chloride materials. The plasticizers of the invention are useful in the production of semi-rigid polyvinyl chloride compositions which typically contain from 10 to 40 phr, preferably 15 to 35 phr, more preferably 20 to 30 phr of plasticizer (phr=parts per hundred parts PVC); flexible polyvinyl chloride compositions which typically contain from 40 to 60 phr, preferably 44 to 56 phr, more preferably from 48 to 52 phr plasticizer; and highly flexible compositions which typically contain from 70 to 110 phr, preferably 80 to 100 phr, more preferably 90 to 100 phr of plasticizer.

One widespread use of polyvinyl chloride is as a plastisol. A plastisol is a fluid or a paste consisting of a mixture of emulsion polyvinyl chloride and a plasticizer optionally containing various additives, such as those described above. A plastisol is used to produce one or more layers of polyvinyl chloride which are coated, pre-gelled, literally build-up and fused to produce coherent articles of flexible polyvinyl chloride. Plastisols are useful in the production of flooring, tents, tarpaulins, coated fabrics such as automobile upholstery, in car underbody coatings, in mouldings and other consumer products. Plastisols are also used in footwear, fabric coating, toys, vinyl glove, and wallpaper. Plastisols typically contain 40 to 200 phr, more typically 50 to 150 phr, more typically 70 to 120 phr, more typically 90 to 110 phr of plasticizer.

In a preferred embodiment of the invention, one or more (such as two or three) plasticizers produced herein are combined with a polymer such as PVC to form a PVC compound (typically made from suspension PVC) or a PVC paste (typically made from an emulsion PVC). A particularly useful PVC in the PVC compound or paste is one having a K value above 70. Particularly preferred PVC compounds or paste comprise: 20 to 150 phr (parts per hundred of resin) plasticizer(s), more preferably 30 to 70 phr and/or 0.5 to 15 phr stabilizer(s), and/or 1 to 30 phr, preferably 15 to 30 phr, filler(s), even more preferably the filler is calcium carbonate and the stabilizer is a calcium/zinc stabilizer. The above combination is useful in wire and cable coatings, particularly automobile wire and cable coating and or building wire insulation.

### EXAMPLES

The following examples are meant to illustrate the present disclosure and inventive processes, and provide where appropriate, a comparison with other methods, including the products produced thereby. Numerous modifications and variations are possible and it is to be understood that within the scope of the appended claims, the disclosure can be practiced otherwise than as specifically described herein.

### Example 1

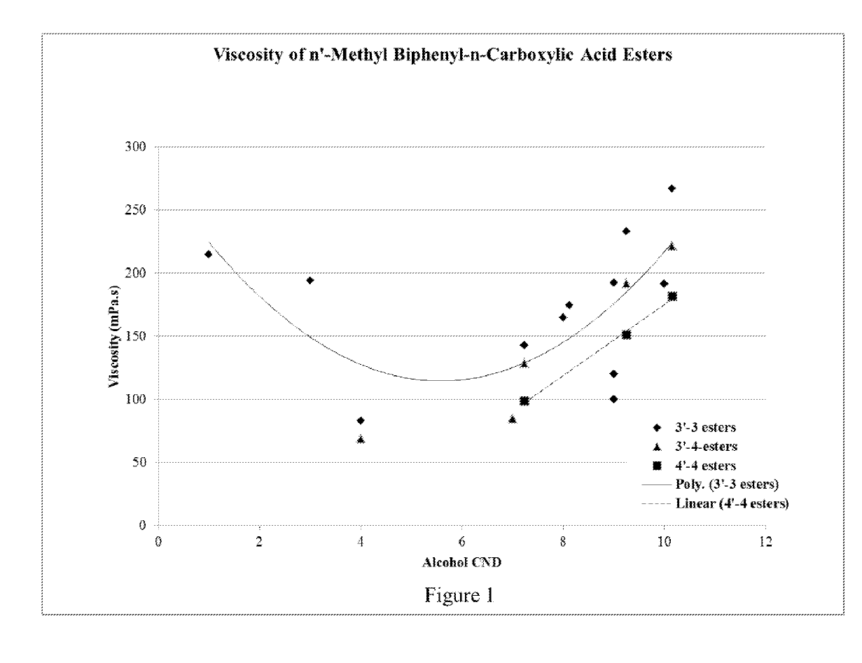

Viscosity of individual isomers of methyl biphenyl carboxylic acid esters are plotted in FIG. 1 where the x-axis indicates the carbon number of the alcohol used to form the R2 alkyl moiety of the ester. The polynomial curve fit of the 3′-3 isomer ester measurements indicates a viscosity minimum for esters of C₄ to C₆ alcohols.

### Example 2

Isomer mixture composition of sample methyl biphenyl carboxylic acid ester of C₄, C₇, and C₉ alcohols are indicated in Table 1 below.

TABLE 1
Isomer Composition of Sample Methyl Biphenyl Carboxylic Acid Esters

| Sample | Isomer Composition and Alkyl Carbon Number |
|---|---|
| S1 | 65 wt % 3′-4 isomer ester of C₄ alcohol/35 wt % 4′-4 isomer ester of C₄ alcohol |
| S2 | 65 wt % 3′-4 isomer ester of C₇ alcohol/35 wt % 4′-4 isomer ester of C₇ alcohol |
| S3 | 65 wt % 3′-4 isomer ester of C₉ alcohol/35 wt % 4′-4 isomer ester of C₉ alcohol |
| S4 | 75 wt % 3′-4 isomer ester of C₉ alcohol/25 wt % 4′-4 isomer ester of C₉ alcohol |
| 55 | 75 wt % 3′-4 isomer ester of C₇ alcohol/25 wt % 4′-4 isomer ester of C₇ alcohol |
| S6 | 100 wt % 3′-4 isomer ester of C₄ alcohol |

Table 2 indicates the viscosity of the neat sample esters S1-S3, example blends B1 and B2, as well as comparative blend B3. Viscosity of the example blends B1 and B2 are desirably ≦120 mPa·s whereas comparative blend B3 has a higher viscosity above 120 mPa·s.

TABLE 2
Viscosity of Methyl Biphenyl Carboxylic Acid Esters and Ester Blends

| Sample or Blend | Viscosity (mPa · s) |
|---|---|
| S1 | 63 |
| S2 | 118 |
| S3 | 178 |
| B1 (50 wt % S1/50 wt % S2) | 85 |
| B2 (50 wt % S1/50 wt % S3) | 100 |
| B3 (50 wt % S2/50 wt % S3) | 142 |

Viscosity (mPa·s) measured at 20° C. using Antoon Paar viscometer following ASTM D445.

A non-limiting example application of the inventive blends is reducing the viscosity of a plasticizer blend comprising a first group of methyl biphenyl carboxylic acid esters of heptyl or nonyl alcohol and a second group of methyl biphenyl carboxylic acid ester of C₄ alcohol.

### Example 3

Flow properties of plastisols are important in spread coating processes like wall covering, flooring or coated fabrics. In general, a low viscosity is desired at high shear rate. PVC plastisol formulations are indicated in Table 3 below. PVC plastisols were prepared by mixing in a Hobart mixer. The plastisols were prepared with 100 parts per hundred of PVC, 40 parts of plasticizer, and 2 parts of a conventional CaZn stabilizer. Formulation T8 contained DINP as a plasticizer for comparative purposes.

TABLE 3
Viscosity of Methyl Biphenyl Carboxylic Acid Esters and Ester Blends

| | T8 | T9 | T10 | T11 | T25 |
|---|---|---|---|---|---|
| Solvin 382 NG | 80 | 80 | 80 | 80 | 80 |
| Solvin 266 SF | 20 | 20 | 20 | 20 | 20 |
| DINP | 40 | | | | |
| S4 | | 40 | | 20 | |
| S5 | | | 40 | | 30 |
| S6 | | | | 20 | 10 |
| Barostab CT9183XRF | 2 | 2 | 2 | 2 | 2 |

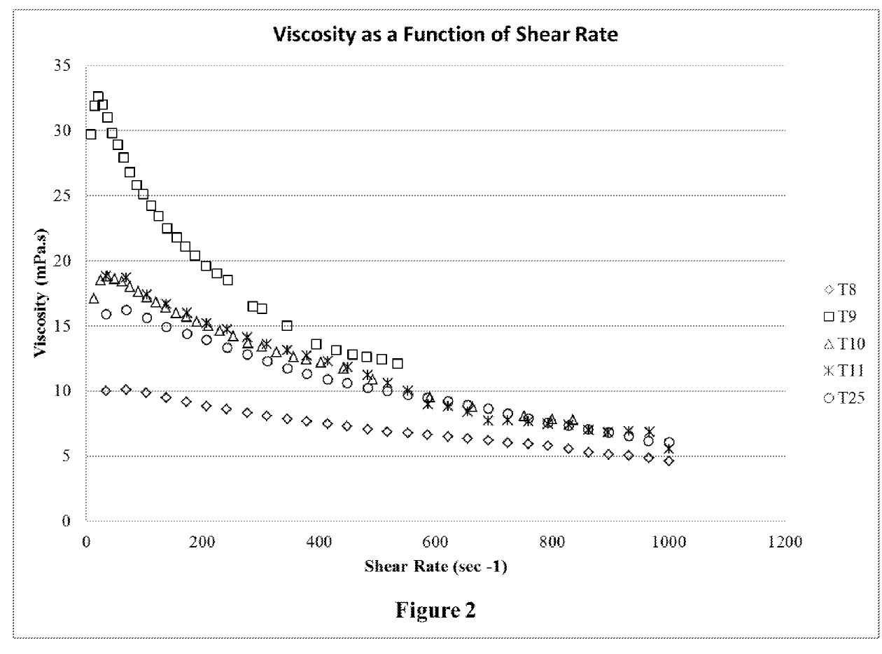

FIG. 2 indicates viscosity of the above plastisol formulations as a function of shear rate. Formulation T9 plastisol viscosity (containing the sample S4 methyl biphenyl carboxylic esters of C₉ alcohol) can be reduced by increasing the concentration of a C₄ alcohol based ester in the blend (formulation T11). The increased C₄ ester concentration lowers initial plastisol viscosity (at low shear) as well as the viscosity under higher shear stress (1000 sec-1) as shown on the plastisol viscosity curves of FIG. 2.

Similarly formulation T10 plastisol viscosity (containing the S5 methyl biphenyl carboxylic esters of C₇ alcohol) can be reduced by increasing the concentration of a C₄ alcohol based ester in the blend (formulation T25). The increased C₄ ester concentration lowers initial viscosity (at low shear) as well as the viscosity under higher shear stress (1000 sec-1), as shown in FIG. 2.

### Example 5

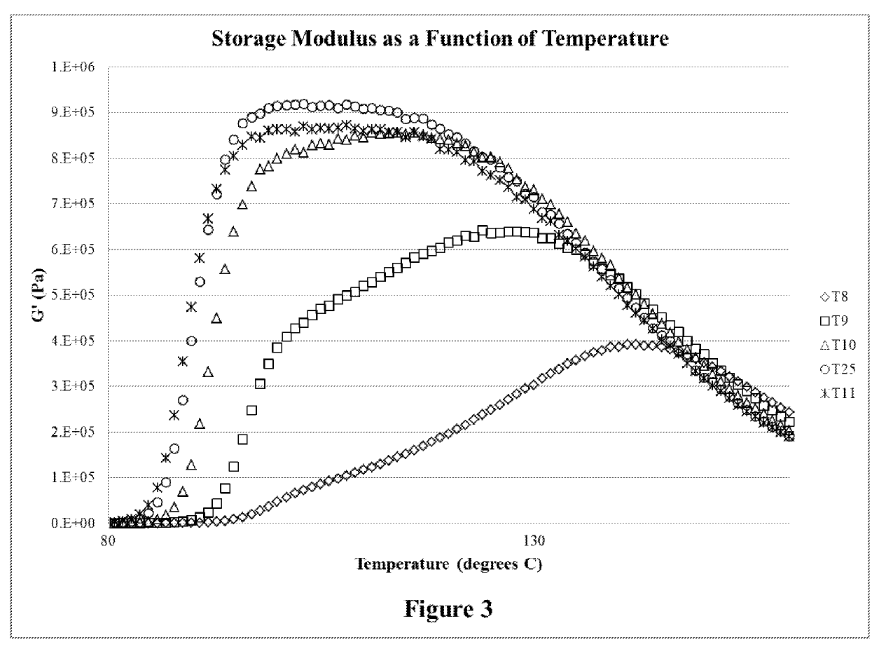

When processing plastisols the gelling energy is worked only by heat-transfer. The higher the processing temperature needed, the longer the time needed to achieve the plastisol gelation. Processors require plasticizers and plastisols with low processing temperature (faster gelling). The rate of plastisol storage modulus increase (G′ storage modulus) gives an indication of the plasticizer faster gelling ability. Gelation behavior, from initial gelation and final gelation up to fusion, was obtained for the above plastisol formulations using DMA technique (dynamic mechanical analyzer) as indicated in FIG. 3.

Plastisols gelation curve are measured using Anton Paar PHYSICA MCR 101 Rheometer equipped with the plate/plate measuring geometry. Settings are PP 50-frequency 1 Hz-amplitude 0.1%-heating rate 10° C./min-start temperature 20° C.-gap: 1 mm-end temperature 195° C., Normal force=0 Newton.

When Gelation begins, both moduli (G′, G″) and complex viscosity (η*) rise sharply. Plasticizer begins to interact with the outer part of the PVC resin particles. When Gelation stage is completed, both moduli (G′, G″) and complex viscosity (η*) reach a maximum. The whole plasticizer has been absorbed by the PVC resin. When Fusion takes place, drop-off of the elastic and viscous moduli is observed. Melting of crystalline portion of the PVC occurs.

The increased rate of the G′ (storage modulus) as function of the temperature of the formulation T9 plastisol (containing the methyl biphenyl carboxylic ester of C₉ alcohol) can be improved by increasing the concentration of a C₄ alcohol based ester in the blend (formulation T11). Similar results are obtained when comparing formulation T10 with formulation T25. The maximum level achieved by the storage modulus is also much higher for the blends with C₄, confirming that the blend is faster fusing.

The meanings of terms used herein shall take their ordinary meaning in the art; reference shall be taken, in particular, to Handbook of Petroleum Refining Processes, Third Edition, Robert A. Meyers, Editor, McGraw-Hill (2004). In addition, all patents and patent applications (including priority documents), test procedures (such as ASTM methods), and other documents cited herein are fully incorporated by reference to the extent such disclosure is not inconsistent with this disclosure and for all jurisdictions in which such incorporation is permitted. Also, when numerical lower limits and numerical upper limits are listed herein, ranges from any lower limit to any upper limit are contemplated. Note further that Trade Names used herein are indicated by a™ symbol, indicating that the names may be protected by certain trademark rights, e.g., they may be registered trademarks in various jurisdictions.

The disclosure has been described above with reference to numerous embodiments and specific examples. Many variations will suggest themselves to those skilled in this art in light of the above detailed description. All such obvious variations are within the full intended scope of the appended claims.

What is claimed is:

1. A blend comprising:
(a) a first group of methyl biphenyl carboxylic acid esters corresponding to the following Formula I: 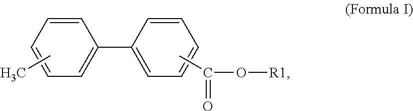
where R1 is a C₇ to C₁₃ alkyl residue of a C₇ to C₁₃ alcohol; and
(b) a second group of methyl biphenyl carboxylic acid esters corresponding to the following Formula II: 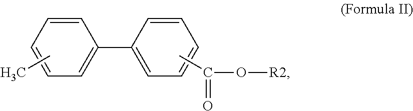
where R2 is a C₄ to C₆ alkyl residue of a C₄ to C₆ alcohol.

2. The blend of claim 1, wherein R1 is a C₉ to C₁₁ alkyl residue of a C₉ to C₁₁ alcohol.

3. The blend of claim 1, wherein R1 is an alkyl residue of an alcohol having a degree of branching from 0.0 to 3.0 and an average carbon number from 9.0 to 9.4, and wherein R2 is an alkyl residue of an alcohol having an average carbon number from 4.0 to 6.0.

4. The blend of claim 1, wherein R1 and R2 are alkyl residues of oxo-alcohols.

5. The blend of claim 1, wherein R1 is an alkyl residue of n-nonanol.

6. The blend of claim 1, wherein either or both of the first group or the second group of methyl biphenyl carboxylic acid esters are para-para (4′-4), meta-para (3′-4), and/or para-meta (4′-3) isomers.

7. The blend of claim 1, wherein either or both of the first group and the second group of methyl biphenyl carboxylic acid esters comprises from 20 to 50 wt % of para-para (4′-4), from 50 to 80 wt % para-meta (4′-3) isomers and/or meta-para (3′-4) isomers, and ≦15 wt % meta-meta (3′-3) isomers.

8. The blend of claim 1, wherein the blend comprises ≧1 wt % of the second group of methyl biphenyl carboxylic acid esters.

9. The blend of claim 1, wherein the first group of methyl biphenyl carboxylic acid esters is present at 0.1 to 99.9 wt % and the second group of methyl biphenyl carboxylic acid esters is present at 99.9 to 0.1 wt %, based upon the weight of the blend.

10. A polymer composition comprising a thermoplastic polymer and a plasticizer blend, wherein the plasticizer blend comprises:
(a) a first group of methyl biphenyl carboxylic acid esters corresponding to the following Formula I: 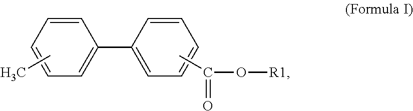
where R1 is a C₇ to C₁₃ alkyl residue of a C₇ to C₁₃ alcohol; and
(b) a second group of methyl biphenyl carboxylic acid esters corresponding to the following Formula II: 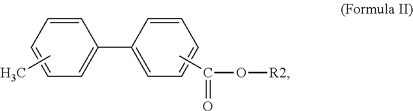
where R2 is a C₄ to C₆ alkyl residue of C₄ to C₆ alcohol.

11. The polymer composition of claim 10, wherein R1 is a C₉ to C₁₁ alkyl residue of a C₉ to C₁₁ alcohol.

12. The polymer composition of claim 10, wherein R1 is an alkyl residue of an alcohol having a degree of branching from 0.0 to 3.0 and an average carbon number from 9.0 to 9.4, and wherein R2 is an alkyl residue of an alcohol having an average carbon number from 4.0 to 6.0.

13. The polymer composition of claim 10, wherein R1 are R2 are alkyl residues of oxo-alcohols.

14. The polymer composition of claim 10, wherein R1 is an alkyl residue of n-nonanol, and wherein R2 is an alkyl residue of oxo-alcohol.

15. The polymer composition of claim 10, wherein either or both of the first group or the second group of methyl biphenyl carboxylic acid esters are para-para (4′-4), meta-para (3′-4), and/or para-meta (4′-3) isomers.

16. The polymer composition of claim 10, wherein either or both of the first group and the second group of methyl biphenyl carboxylic acid esters comprises from 20 to 50 wt % of para-para (4′-4) and/or meta-para (3′-4) isomers, from 50 to 80 wt % para-meta (4′-3) isomers, and ≦15 wt % meta-meta (3′-3) isomers.

17. The polymer composition of claim 10, wherein the first group of methyl biphenyl carboxylic acid esters is present at 0.1 to 99.9 wt % and the second group of methyl biphenyl carboxylic acid esters is present at 99.9 to 0.1 wt %, based upon the weight of the blend.

18. The polymer composition of claim 10, wherein the thermoplastic polymer is selected from the group consisting of vinyl chloride resins, polyesters, sylil-terminated polyethers, polyurethanes, ethylene-vinyl acetate copolymer, rubbers, poly(meth)acrylics and combinations thereof.

19. The polymer composition of claim 10, wherein the thermoplastic polymer is selected from the group consisting of polyvinyl chloride (PVC), polyvinylidene chloride, a copolymer of polyvinyl chloride and polyvinylidene chloride, and polyalkyl methacrylate (PAMA).

20. The polymer composition of claim 10, wherein the polymer composition is a plastisol.

21. A process for making a blend of methyl biphenyl carboxylic acid esters, comprising the steps of: reacting benzene or alkylated benzene under conditions appropriate to form methyl biphenyl; oxidizing the alkyl group(s) on said alkylated biphenyl to form at least one acid group; contacting a first portion of said acid group(s) with C₇ to C₁₃ alcohols under esterification conditions to form first group of methyl biphenyl ester(s); contacting a second portion of said acid group(s) with C₄ to C₆ alcohols under esterification conditions to form second group of methyl biphenyl ester(s); and mixing the first and second ester groups to form said blend.

22. The process of claim 21 wherein the first portion of said acid group(s) is contacted with C₉ to C₁₁ alcohols.

23. The process of claim 21 wherein the first portion of said acid group(s) is contacted with alcohols having a degree of branching from 0.0 to 3.0 and an average carbon number (ACN) from 9.0 to 9.4.
